(19) United States
(12) Patent Application Publication
(10) Pub. No.: US 2026/0153028 A1
(43) Pub. Date: Jun. 4, 2026

(54) SPECTRAL MEAN NORMALIZATION METHOD FOR MINIMIZING ROTATION EFFECT FROM DRILL BIT SOUNDS

(71) Applicant: SAUDI ARABIAN OIL COMPANY, Dhahran (SA)

(72) Inventors: Wei Li, Beijing (CN); Yunlai Yang, Dhahran (SA)

(73) Assignees: SAUDI ARABIAN OIL COMPANY, Dhahran (SA); ARAMCO FAR EAST (BEIJING) BUSINESS SERVICES CO., LTD, Beijing (CN)

(21) Appl. No.: 18/716,298

(22) PCT Filed: Mar. 7, 2023
(86) PCT No.: PCT/CN2023/080031

§ 371 Date: Jun. 4, 2024

(51) Int. Cl. E21B 49/00; E21B 7/04; E21B 44/00; G01V 1/50

(52) U.S. Cl. CPC E21B 49/003; E21B 44/00; G01V 1/50; E21B 7/04; G01V 2210/1216

(57) ABSTRACT

A method and systems for steering a drill bitbased on the drill bit sounds are disclosed. The drill bit sounds are analyzed during drilling to predict formation rock properties in real time for use in real time geo-steering. The effect of the drill bit rotation is minimized from the drill bit sounds to improve the quality of recorded drill bit sounds. Specifically, the recorded drill sounds are transformed to frequency domain using Fast Fourier Transform (FFT) method to generate the spectra of the drill bit sounds. A spectral bottom-envelop is calculated from the entire spectra data record to represent the effect of the drill bit rotation rate on the drill bit sounds. Accordingly, the spectral bottom-envelop is used to minimize the effect of the drill bit rotation in generating a normalized drill bit sounds to facilitate geo-steering of the drilling operation.

### BACKGROUND

Conventional Logging While Drilling (LWD) tools are usually located 30-50 feet behind the drill bit. As a result, the information gathered by the LWD tools for steering the drill bit (i.e., geo-steering) is not the true real time information. Drill bit sounds refer to audio signals from the drill bit when cutting the formation rock downhole during drilling of the formation. Since drill bit sounds are generated at the drill bit, the drill bit sound signal is a true real time signal. When formation rock changes, the drill bit sounds change accordingly. Therefore, by analyzing drill bit sounds, formation rock properties can be predicted during drilling in real time. Further, the drill string rotation affects the quality of recorded drill bit sounds. What is needed is a method to reduce the effects of drill string rotation on the quality of recorded drill bit sounds.

### SUMMARY

In general, in one aspect, embodiments disclosed herein relate to a method for drilling a subterranean formation. The method includes generating a digitized data log of drilling sound waves from a drill bit while the drill bit advances through a depth range in the subterranean formation by cutting formation rocks to form a borehole, wherein the digitized data log comprises a plurality of drill bit sounds samples corresponding to a plurality of drilling depths throughout the depth range, converting the digitized data log into frequency domain data (FFT data), generating a first rotation rate cluster and a second rotation rate cluster from a rotation rate log of the drill bit advancing through the depth range, generating a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster, generating a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster, generating a scaled SMC from the first SMC and the second SMC, wherein the scaled SMC represents the effect of the rotation rate on the drilling sound waves as a function of the rotation rate, generating, based on the scaled SMC and the rotation rate log, a normalized FFT data from the FFT data, wherein the effect of the rotation rate on the drilling sound waves is reduced in the normalized FFT data, and facilitating a drilling operation based on the normalized FFT data.

In general, in one aspect, embodiments disclosed herein relate to a data gathering and analysis system for facilitating a drilling operation of a subterranean formation. The data gathering and analysis system includes a computer processor, and memory coupled to the computer processor and comprising instructions, when executed causing the computer processor to generate a digitized data log of drilling sound waves from a drill bit while the drill bit advances through a depth range in the subterranean formation by cutting formation rocks to form a borehole, wherein the digitized data log comprises a plurality of drill bit sounds samples corresponding to a plurality of drilling depths throughout the depth range, convert the digitized data log into frequency domain data (FFT data), generating a first rotation rate cluster and a second rotation rate cluster from a rotation rate log of the drill bit advancing through the depth range, generate a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster, generate a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster, generate a scaled SMC from the first SMC and the second SMC, wherein the scaled SMC represents the effect of the rotation rate on the drilling sound waves as a function of the rotation rate, generate, based on the scaled SMC and the rotation rate log, a normalized FFT data from the FFT data, wherein the effect of the rotation rate on the drilling sound waves is reduced in the normalized FFT data, and facilitate the drilling operation based on the normalized FFT data.

In general, in one aspect, embodiments disclosed herein relate to a well system for performing a drilling operation of a subterranean formation. The well system includes a drill bit coupled to a drill string that is suspended in a borehole penetrating the subterranean formation, and a data gathering and analysis system configured to generate a digitized data log of drilling sound waves from the drill bit while the drill bit advances through a depth range in the subterranean formation by cutting formation rocks to form the borehole, wherein the digitized data log comprises a plurality of drill bit sounds samples corresponding to a plurality of drilling depths throughout the depth range, convert the digitized data log into frequency domain data (FFT data), generating a first rotation rate cluster and a second rotation rate cluster from a rotation rate log of the drill bit advancing through the depth range, generate a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster, generate a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster, generate a scaled SMC from the first SMC and the second SMC, wherein the scaled SMC represents the effect of the rotation rate on the drilling sound waves as a function of the rotation rate, generate, based on the scaled SMC and the rotation rate log, a normalized FFT data from the FFT data, wherein the effect of the rotation rate on the drilling sound waves is reduced in the normalized FFT data, and facilitate the drilling operation based on the normalized FFT data.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a flowchart in accordance with one or more embodiments.

FIGS. 3A-3K show an example in accordance with one or more embodiments.

FIG. 4 shows a computing system in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a system and method for steering the drill bit (i.e., geo-steering) based on the drill bit sounds. In one or more embodiments, the drill bit sounds are analyzed during drilling to predict formation rock properties in real time for use in real time geo-steering. For example, the real time geo-steering enables the drilling operator to identify formation boundaries and rock types, to improve or enhance drilling operations, such as precisely positioning the casing shoe by knowing where the rock boundaries are.

In one or more embodiments of the invention, the effect of the drill bit rotation is minimized from the drill bit sounds to improve the quality of recorded drill bit sounds. Specifically, the recorded drill sounds are transformed to frequency domain using Fast Fourier Transform (FFT) method, to generate the spectra of the drill bit sounds. A spectral bottom-envelop is calculated from the entire spectra data record to represent the effect of the drill bit rotation rate on the drill bit sounds. Accordingly, the spectral bottom-envelop is used to minimize the effect of the drill bit rotation in generating a normalized drill bit sounds to facilitate geo-steering of the drilling operation.

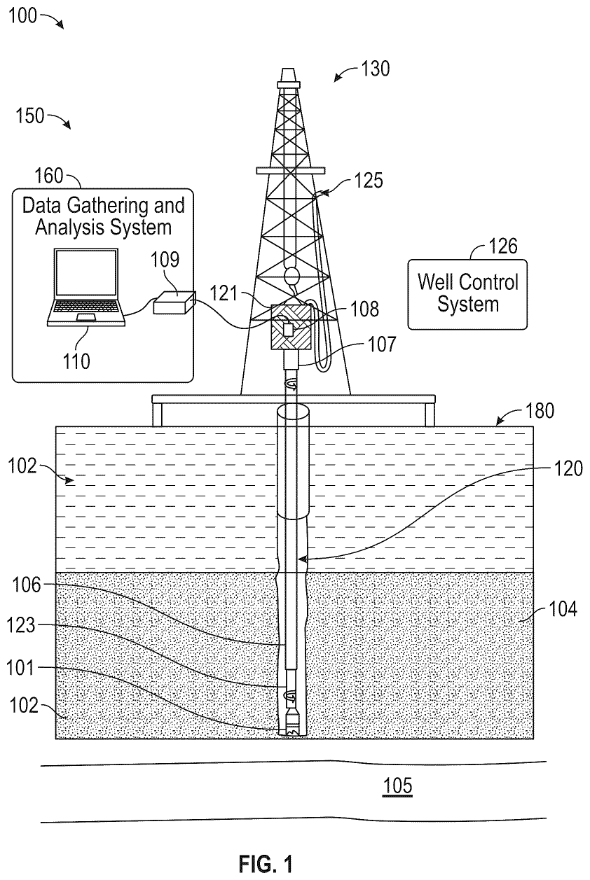

FIG. 1 shows a schematic diagram in accordance with one or more embodiments. As shown in FIG. 1, a well environment (100) includes a subterranean formation (“formation”) (104) and a well system (150). The formation (104) may include a porous or fractured rock formation that resides underground, beneath the earth's surface (“surface”) (180). The formation (104) may include different layers (102) of rock having varying characteristics, such as varying degrees of permeability, porosity, capillary pressure, and resistivity. In the case of the well system (150) being a hydrocarbon well, the formation (104) may include a hydrocarbon-bearing reservoir (105). In the case of the well system (150) being operated as a production well, the well system (150) may facilitate the extraction of hydrocarbons (or “production”) from the reservoir (105).

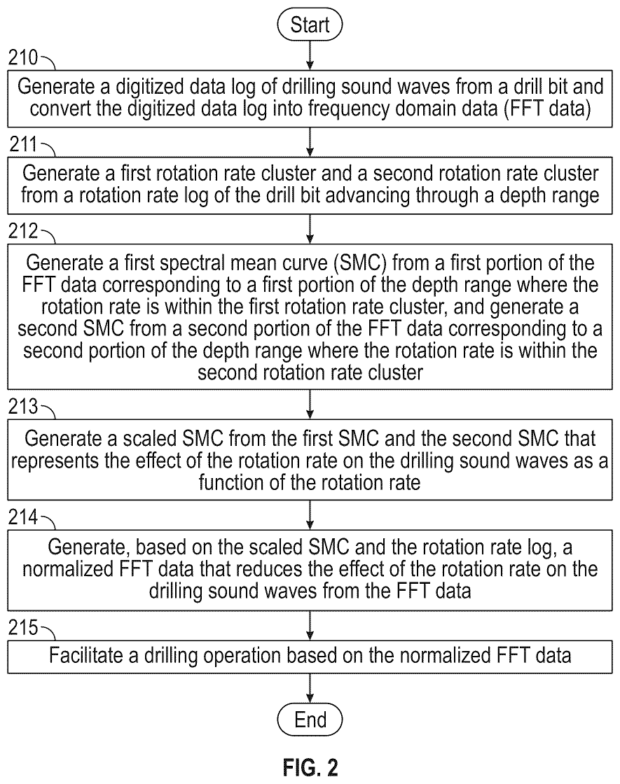

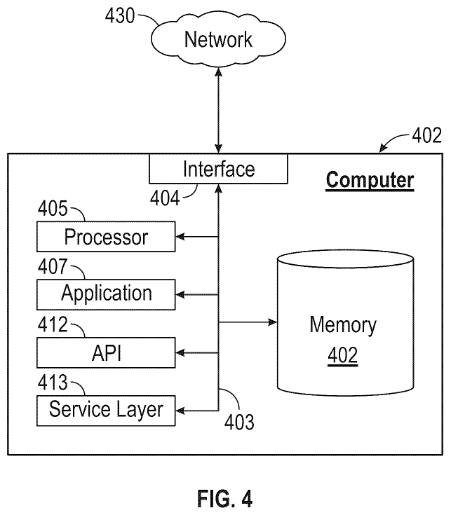

In some embodiments disclosed herein, the well system (150) includes a rig (130), a wellbore (120), a data gathering and analysis system (160), and a well control system (126). The well control system (126) may control various operations of the well system (150), such as well drilling operation, well completion operations, well production operations, well maintenance operations, and reservoir monitoring, assessment and development operations. In some embodiments, the data gathering and analysis system (160) includes hardware and/or software with functionality for facilitating the well control system (126) to control operations of the well system (150). For example, the data gathering and analysis system (160) includes a data acquisition unit (109) and a computer (110) that communicate with the sensor (108) to retrieve and analyze sensor measurements to facilitate the operations of the well system (150), such as the drilling operation. Accordingly, the data gathering and analysis system (160) may generate control signals, based on the analysis results of the sensor measurements, for the well control system (126) to control the drilling operation in real time. In one or more embodiments, the data gathering and analysis system (160) and the well control system (126) collectively perform these functionalities using the method described in reference to FIG. 2 below. In some embodiments, the data gathering and analysis system (160) and the well control system (126) include one or more computer systems, such as a portion of the computer system described in reference to FIG. 4 below. While the data gathering and analysis system (160) and the well control system (126) are shown at a well site, embodiments are contemplated where at least a portion of the data gathering and analysis system (160) and the well control system (126) is located away from well sites.

The rig (130) is the machine used to drill a borehole to form the wellbore (120). Major components of the rig (130) include a drill string (106), a rotary table or top drive (121), drilling fluid tanks and drilling fluid pumps (e.g., rig mixing pumps), the derrick or mast, the draw works, and the power generation and auxiliary equipment. Drilling fluid (125), also referred to as “drilling mud” or simply “mud,” is used to facilitate drilling boreholes into the earth, such as drilling oil and natural gas wells. The main functions of drilling fluids (125) include providing hydrostatic pressure to prevent formation fluids from entering into the borehole, keeping the drill bit cool and clean during drilling, carrying out drill cuttings, and suspending the drill cuttings while drilling is paused and when the drilling assembly is brought in and out of the borehole.

The wellbore (120) includes a bored hole (i.e., borehole) that extends from the surface (180) towards a target zone of the formation (104), such as the reservoir (105). An upper end of the wellbore (120), terminating at or near the surface (180), may be referred to as the “up-hole” end of the wellbore (120), and a lower end of the wellbore, terminating in the formation (104), may be referred to as the “downhole” end of the wellbore (120). The wellbore (120) may facilitate the circulation of drilling fluids (125) during drilling operations for the wellbore (120) to extend towards the target zone of the formation (104) (e.g., the reservoir (105)), facilitate the flow of hydrocarbon production (e.g., oil and gas) from the reservoir (105) to the surface (180) during production operations, facilitate the injection of substances (e.g., water) into the hydrocarbon-bearing formation (104) or the reservoir (105) during injection operations, or facilitate the communication of monitoring devices (e.g., logging tools) lowered into the formation (104) or the reservoir (105) during monitoring operations (e.g., during in situ logging operations).

In some embodiments, the well system (150) is provided with a bottom hole assembly (BHA) attached to the drill string (106) to suspend into the wellbore (120) for performing the well drilling operation. The bottom hole assembly (BHA) is the lowest part of the drill string (106) and includes a drill bit (101), drill collar, stabilizer, mud motor (123), etc. As shown in FIG. 1, the wellbore (120) is drilled by the drill bit (101) suspended from the rig (130)) cutting into the underground rocks in the formation (104). The cutting is accomplished by the rotation of the drill bit (101). Generally, the rotation of the drill bit (101) is generated by the top drive (121) through a drive shaft (107) connected to the drill string (106). When the mud motor 123 is used to aid directional drilling, the drill bit (101) is also rotated by the mud motor (123), which is driven by the injected drilling mud (125). In such configuration, the drill bit rotation rate is the summation of rotation rates of the top drive (121) and the mud motor (123). In a special drilling mode, referred to as “sliding mode”, the drill bit (101) is only rotated by the mud motor (123).

When the drill bit (101) drills into different rock types in the formation (104) or different formation layers (102) with different properties (e.g., porosity, water saturation, permeability, presence of fractures, etc.), the generated drilling sound waves emanating from the drill bit (101) against the contacted rocks are distinctively different. In some embodiments, the drilling sound waves transmit/propagate upward along the drill string (106) and are captured by one or more acoustic sensors (108) attached to the drive shaft (107) directly or through an extension of the drive shaft (107). In alternative embodiments, the drilling sound waves are captured by one or more acoustic sensors attached to a downhole subassembly (not shown) adjacent to the drill bit (101). The drilling sound waves captured by the sensors are digitized by the data acquisition unit (109) where the digitized data are then transmitted to the computer (110) to be recorded as a drill bit sounds sample for each drilling depth. The drill bit sounds samples across a range of drilling depths are then compiled into a data log with respect to drilling depth. Throughout this disclosure, the recorded digitized data log of the drilling sound waves is referred to as drill bit sounds.

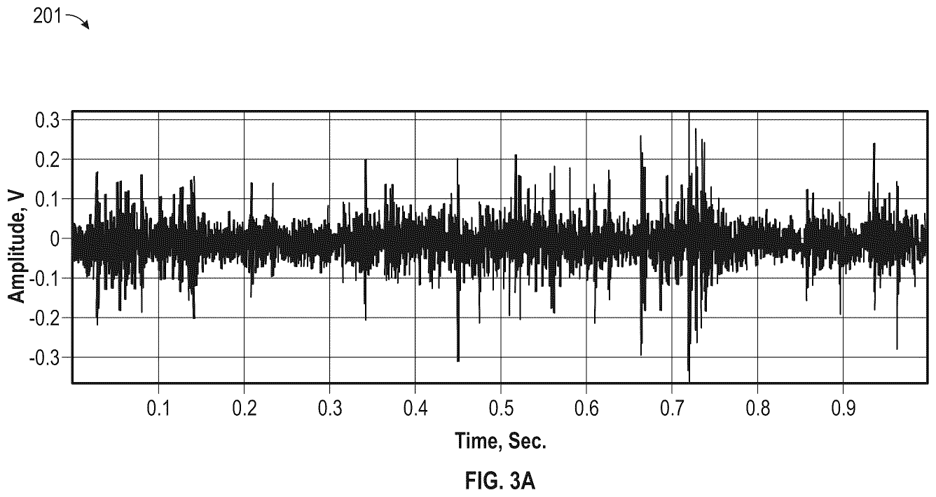

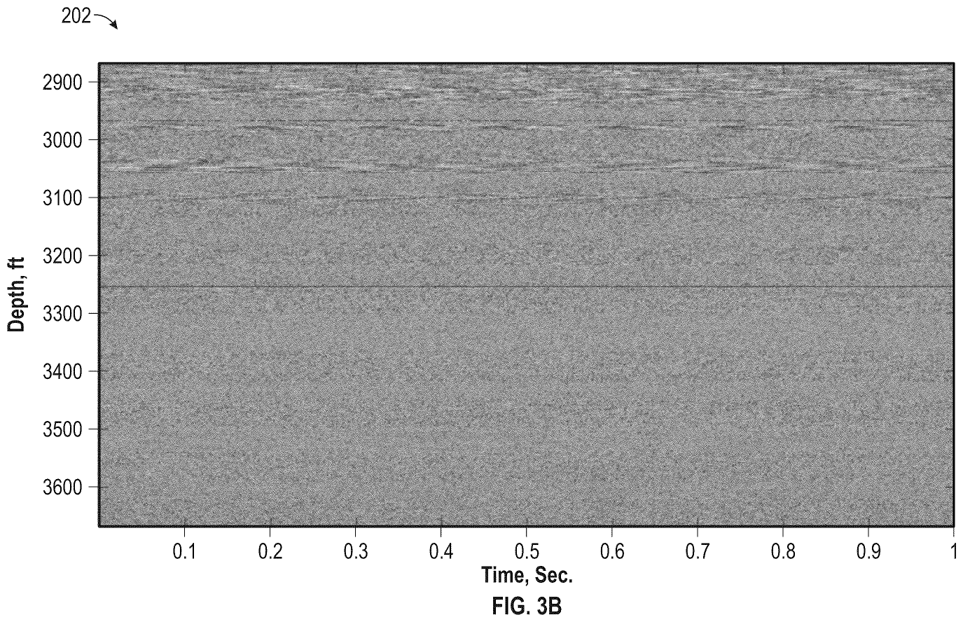

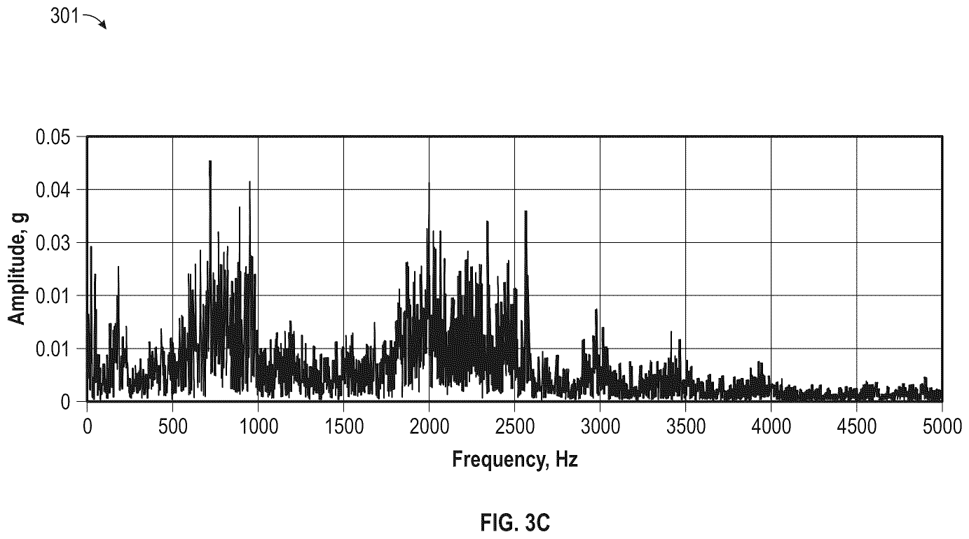

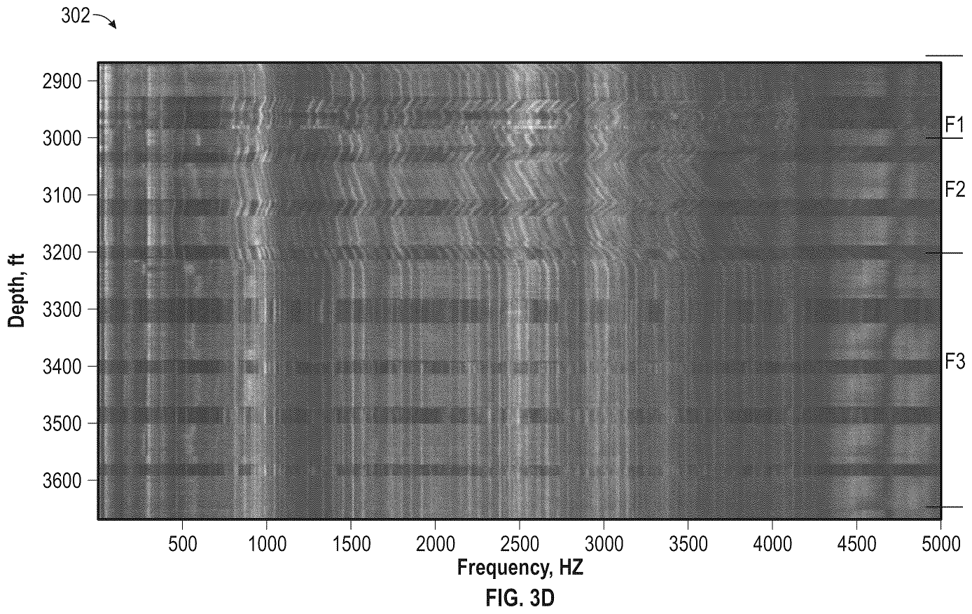

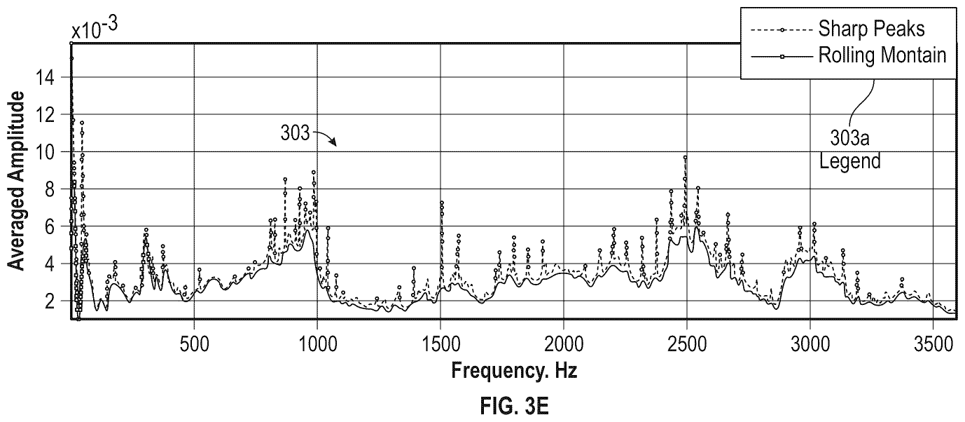

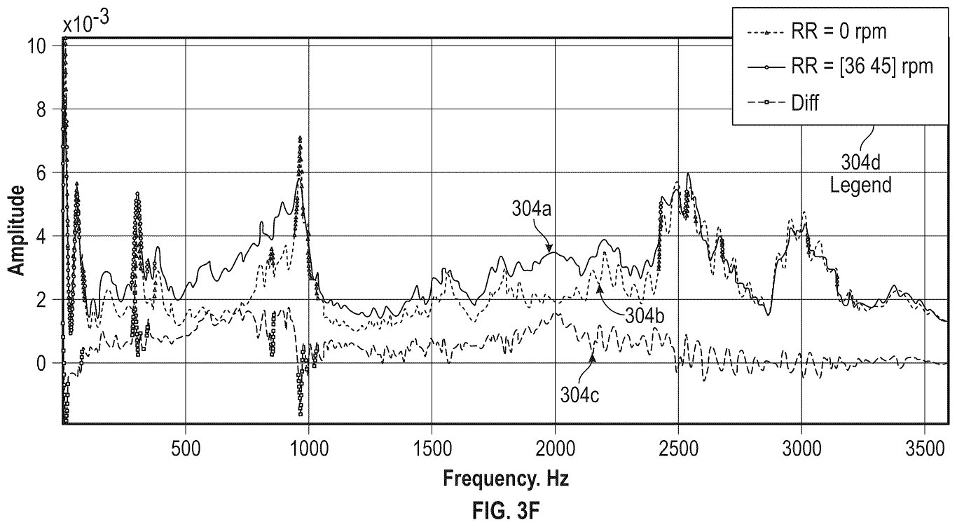

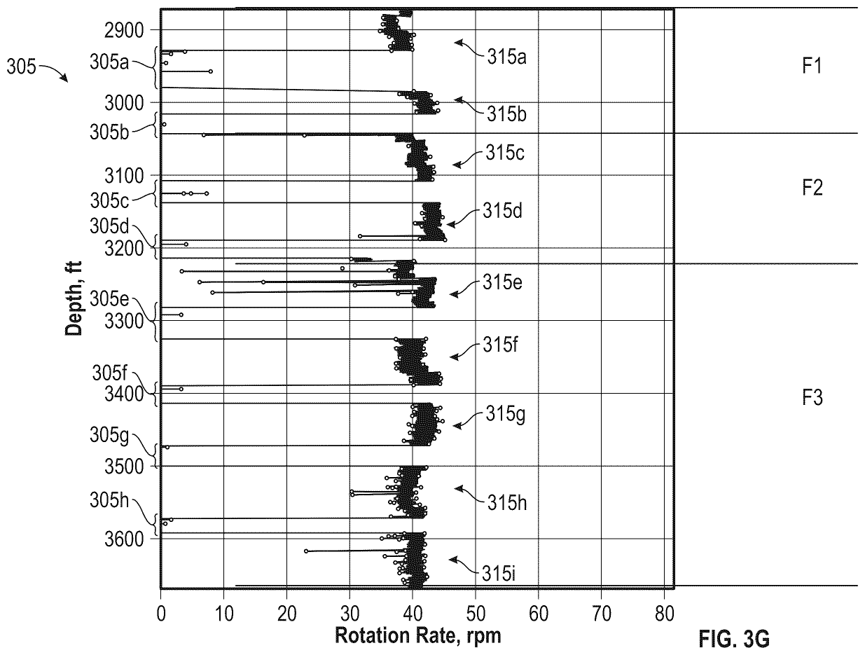

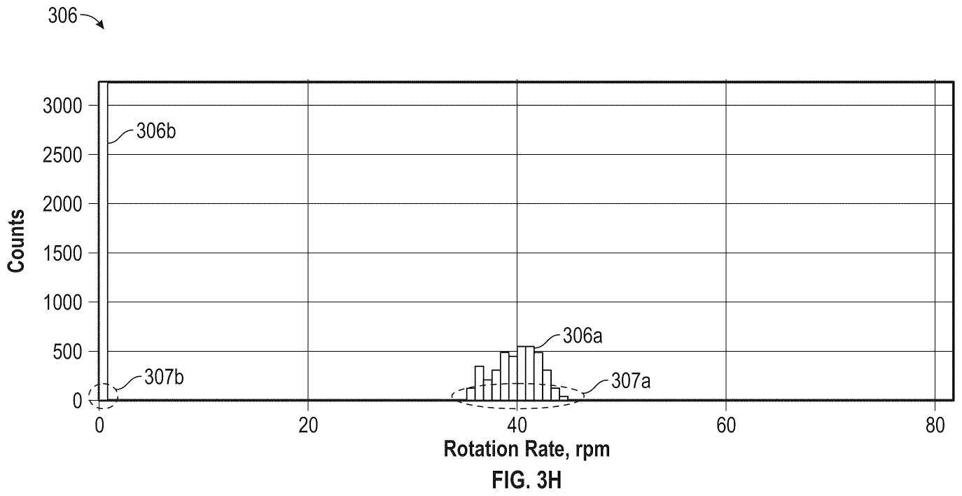

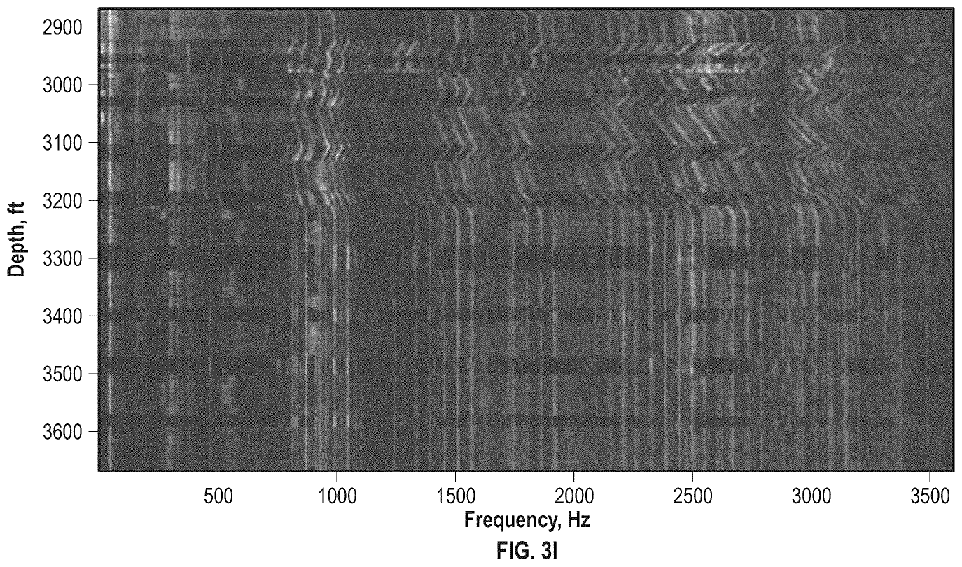

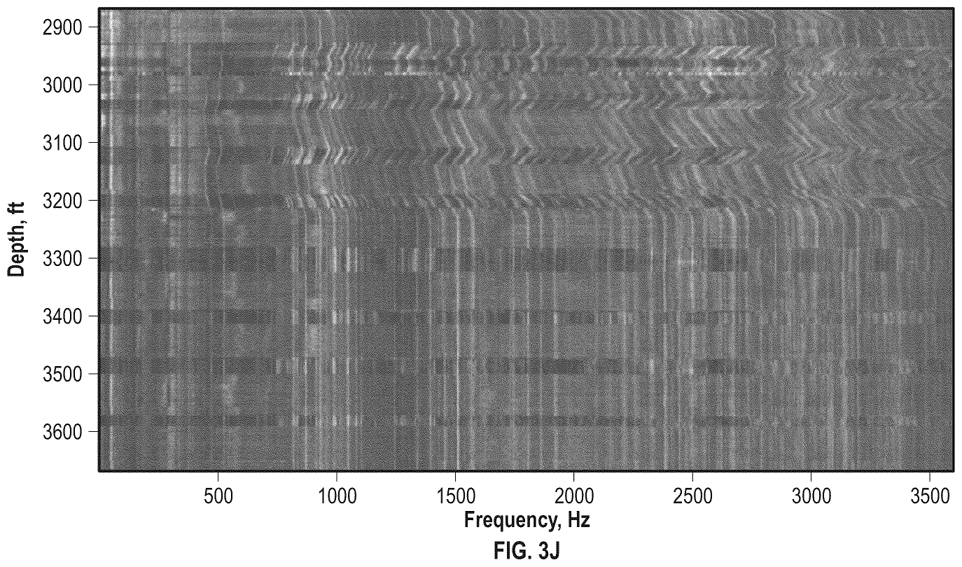

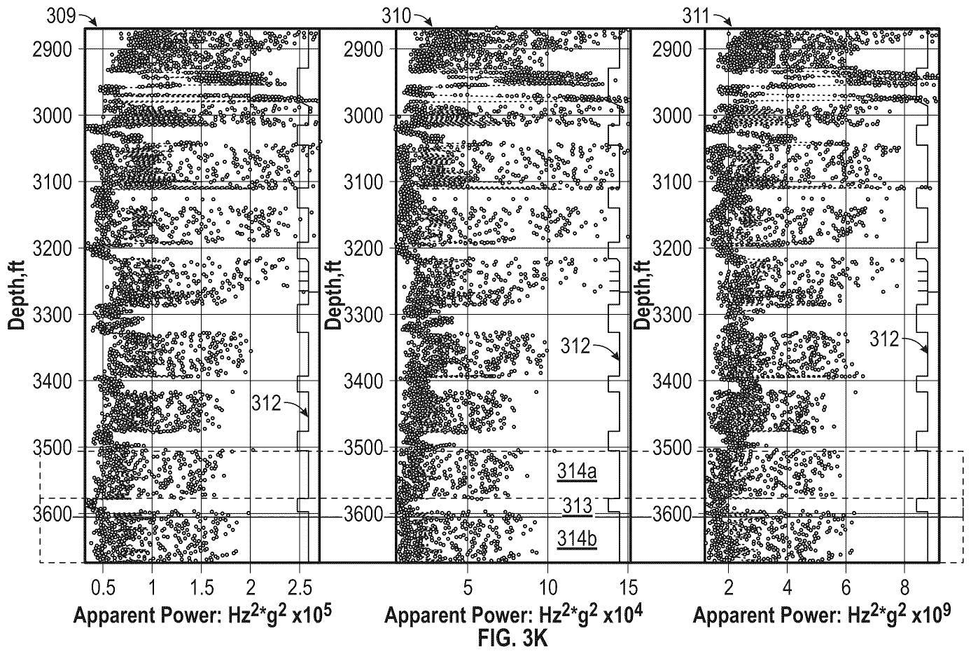

An example of recorded drill bit sounds is illustrated in FIGS. 3A-3D. As shown in FIG. 3A, plot (201) represents one drill bit sounds sample obtained when the drill bit (101) is at a particular depth and recorded within a time window of one second. In the plot (201), the vertical axis corresponds to an amplitude of the recorded digitized data while the horizontal axis corresponds to time.

As shown in FIG. 3B, plot (202) shows a pixel image that represents multiple drill bit sounds samples obtained when the drill bit (101) progresses through a depth range and recorded within the same time window of one second. In the plot (202), the vertical axis corresponds to the drill bit depth, the horizontal axis corresponds to time, and the gray scale intensity of the pixels corresponds to amplitude of the recorded digitized data.

As shown in FIG. 3C, plot (301) represents one drill bit sounds sample in frequency domain. Specifically, the plot (301) is generated by applying the Fast Fourier Transform (FFT) to the drill bit sounds sample shown in plot (201) above. In the plot (301), the vertical axis corresponds to the amplitude of the recorded digitized data while the horizontal axis corresponds to frequency.

As shown in FIG. 3D, plot (302) shows another pixel image that represents multiple drill bit sounds samples in frequency domain. Specifically, the plot (302) is generated by applying the Fast Fourier Transform (FFT) to the multiple drill bit sounds samples shown in plot (202) above. In the plot (302), the vertical axis corresponds to the drill bit depth, the horizontal axis corresponds to frequency, and the gray scale intensity of the pixels corresponds to amplitude of the recorded digitized data. Throughout this disclosure, the data formats illustrated in FIGS. 3A-3B are referred to as time domain data, while the data formats illustrated in FIGS. 3C-3D are referred to as frequency domain data or FFT data.

The drill bit sounds samples shown in FIGS. 3B and 3D above were recorded in three consecutive layers of rock formations that are labeled F1, F2, and F3 along the vertical axis of plot (302) in FIG. 3B. Formation layer 1 (F1) is composed of limestone and clastic sedimentary rocks, formation layer 2 and formation layer 3 (F2 and F3) have similar lithology type of limestone, but with different physical properties, such as porosity and strength. As a result of the differences in lithology type and formation properties, the drill bit sounds in frequency domain have different appearances for these three layers as shown in FIG. 3B.

Turning to FIG. 2, FIG. 2 shows a process flowchart in accordance with one or more embodiments. Compared to a typical well log (i.e., sonic, or gamma ray logs), the drill bit sounds (i.e., recorded digitized data log of the drilling sound waves) include more extensive and complex information of the formation rocks. However, the drill bit sounds are heavily affected by the rotation rate of the drill bit during drilling. The process flowchart depicted in FIG. 2 describes a method to minimize the effect of the drill bit rotation to improve extraction of formation properties from the drill bit sounds. One or more blocks in FIG. 2 may be performed using one or more components as described in FIG. 1. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Block 210, a recorded digitized data log of drill bit sounds is acquired as a drill bit advances to cut formation rocks during drilling of a well. The drill bit sounds are processed into the frequency domain data using FFT. In turn, the frequency domain data (FFT data) of the drill bit sounds are averaged over a depth range to generate an averaged drill bit sounds spectrum curve. The averaged drill bit sounds spectrum curve represents formation rock property information modulated by the effect of drill bit rotation rate.

An example of the averaged drill bit sounds spectrum curve (303) is shown in FIG. 3E, which is generated by averaging the frequency domain data (i.e., gray scale pixel intensity) depicted in FIG. 3D over the entire depth range of the formation layers F1-F3. In one or more embodiments, the averaged drill bit sounds spectrum curve (303) may also be generated by averaging the frequency domain data over part of the depth for real time processing, i.e., the depth range above the current depth. As shown in FIG. 3E, the vertical axis corresponds to the averaged amplitude of the frequency domain data while the horizontal axis corresponds to frequency. According to the legend (303a), the averaged drill bit sounds spectrum curve (303) is shown as high frequency peaks (referred to as “sharp peaks” in the legend (303a)) superimposed over a spectral bottom-envelop (referred to as “rolling mountain” in the legend (303a)). In particular, the “rolling mountain” reflects the effect of the drill bit rotation rate on the drill bit sounds and “sharp peaks” reflects the formation rock properties. Throughout this disclosure, the “rolling mountain” or spectral bottom-envelop is referred to as the “spectral mean curve (SMC).”

In Block 211, a drill bit rotation rate log is analyzed to generate a histogram. The drill bit rotation rate log is segmented into multiple rotation rate ranges based on the histogram. In other words, multiple rotation rate ranges of the drill bit rotation rate log are determined based on the histogram. In one or more embodiments, the histogram includes multiple clusters and each rotation rate range corresponds to one of the clusters. Accordingly, the depth range of the averaged drill bit sounds spectrum curve is segmented into multiple rotation rate depth sections corresponding to the multiple rotation rate ranges. Specifically, the drill bit advances through each rotation rate depth section while rotating within a corresponding rotation rate range.

An example drill bit top drive rotation rate log (305) is shown in FIG. 3G where the vertical axis corresponds to the drilling depth while the horizontal axis corresponds to the drill bit rotation rate driven by the top drive in the rig. The drill bit is driven by mud motor when the top drive rotation rate is zero.

An example histogram (306) of the rotation rate log (305) having two clusters is shown in FIG. 3H. The two clusters correspond to a dominant rotation rate cluster (306a) with values (measured in rotation per minute or rpm) between 36 and 45, and a near zero cluster (306b) with near zero values. Accordingly, the rotation rate log (305) can be segmented into two rotation rate value ranges: a near zero range (307b) of [0-0.1] where the drill bit advances very slowly through each of the near zero rotation rate depth sections (305a-305h), and a non-zero range (307a) of [36-45] where the drill bit advances relatively quickly through each of the non-zero rotation rate depth sections (315a-315i). Outliers are removed during segmentation. For each segment of rotation rate, the effect of rotation rate on drill bit sounds are evaluated. Although two rotation rate value clusters are shown in the example rotation rate log (305) and example histogram (306), more rotation rate value clusters may exist in other examples.

In Block 212, a spectral mean curve (SMC) of the averaged drill bit sounds spectrum curve described in Block 210 is calculated for different rotation rate ranges determined in Block 211.

For the example shown in FIGS. 3E-3H, the spectral mean curves (304a) and (304b) are calculated using the raw drill bit sound spectrum data for the two ranges (307a) and (307b) (i.e., [36-45] and near zero (0)) determined from the averaged drill bit sounds spectrum curve (303). The spectral mean curves (304a) and (304b) and the differences (304c) between the two curves (304a) and (304b) are plotted FIG. 3F according to the legend (304d).

As shown in FIG. 3F, the vertical axis corresponds to the averaged amplitude of the frequency domain data while the horizontal axis corresponds to frequency. In particular, the SMC (304a) corresponds to the rolling mountain of the averaged amplitude of a portion of the frequency domain data within the non-zero rotation rate range (307a) of [36-45]. In other words, the SMC (304a) corresponds to the spectral bottom-envelop of the averaged amplitude from the portion of the raw drill bit sound spectrum data in the depth ranges (315a, 315b, 315c, 315d, 315e, 315f, 315g, 315h, 315i) according to FIGS. 3G and 3H.

In contrast, the SMC (304b) corresponds to the rolling mountain of the averaged amplitude of another portion of the frequency domain data within the near zero rotation rate range (307b) of [0-0.1]. In other words, the SMC (304b) corresponds to the spectral bottom-envelop of the averaged amplitude from the portion of the raw drill bit sound spectrum data in the depth ranges (305a, 305b, 305c, 305d, 305e, 305f, 305g, 305h) according to FIGS. 3G and 3H.

Because the averaged drill bit sounds spectrum curve (303) corresponds to the averaged amplitude of both portions of the frequency domain data encompassing the non-zero rotation rate range (307a) of [36-45] and the near zero rotation rate range (307b) of [0-0.1], the averaged drill bit sounds spectrum curve (303) is a weighted sum of the SMC (304a) and SMC (304b). In this context, the SMC (304a) and SMC (304b) are decomposed portions of the averaged drill bit sounds spectrum curve (303) and are referred to as averaged spectral mean curves. Once the bottom-envelop is calculated (i.e., by connecting all the minimum points of a given curve), the sharp peaks of the averaged drill bit sounds spectrum curve (303) are removed from the SMC (304a) and SMC (304b). Thus, in one or more embodiments, only the two rolling mountains are used for the scaled SMC calculation.

In Block 213, a scaled spectral mean curve (scaled SMC or Smc) is calculated for each drill bit sounds sample at a particular drilling depth. As noted above, the drill bit sounds sample is the digital recording of the drilling acoustic signal sample at a particular drilling depth. Because the rotation rate of each drill bit sounds sample varies according to the drilling depth, the scaled spectral mean curve for each drill bit sounds sample is derived (e.g., using linear interpolation) from the averaged spectral mean curves (e.g., SMC (304a), SMC (304b)) based on the rotation rate. Accordingly, in Block 214 below, the scaled spectral mean curve for each drill bit sounds sample is used to normalize the rotation rate effect for the sample.

The scaled spectral mean curve for a drill bit sounds sample is calculated from the two averaged spectral mean curves (e.g., SMC (304a), SMC (304b)) and the rotation rate log. The detailed procedure is described as below.

1) Calculate the median rotation rate value for a high rotation rate range (e.g., non-zero rotation rate range (307a) of [36-45] rpm) to be denoted as RRₘ, and assign the averaged spectral mean curve for this high rotation rate range (e.g., SMC (304a)) as the scaled spectral mean curve for this median rotation rate value RRₘ. For the example shown in FIGS. 3E and 3H, Smc(RRₘ)=SMC(304a).

2) Calculate the median rotation rate value for a low rotation rate range (e.g., near zero rotation rate range (307b) of [0-0.1] rpm) to be denoted as 0, and assign the averaged spectral mean curve for this low rotation rate range (e.g., SMC(304b)) as the scaled spectral mean curve for this median rotation rate value 0. For the example shown in FIGS. 3E and 3H, Smc(0) SMC(304b).

3) Calculate the scaled spectral mean curve for each drill bit sounds sample using the linear interpolation Equation 1 below:

$$Smc ( rr ) = ( Smc ( {RR}_{m} ) - Smc ( 0 ) ) \times \frac{rr}{{RR}_{m}} + Smc ( 0 ) \qquad Eq . ( 1 )$$

In Equation 1, rr denotes the rotation rate of the drill bit sounds sample; Smc(rr) denotes the scaled spectral mean curve for the rotation rate rr; RRₘ denotes the median rotation rate for the high rotation rate range; Smc(RRₘ) denotes the scaled spectral mean curve for the rotation rate PRₘ, which equals the averaged spectral mean curve (SMC) for the high rotation rate range; Smc(0) the scaled spectral mean curve for the rotation rate 0, which equals the averaged spectral mean curve (SMC) for the low rotation rate range.

The scaled spectral mean curve (i.e., Smc(rr)) represents the effect of the drill bit rotation rate on the drill bit sounds when the drill bit rotates at the rotation rate rr. By looking up the rotation rate rr from the rotation rate log (e.g., rotation rate log (305) depicted in FIG. 3G), the effect of the drill bit rotation rate on the drill bit sounds at any particular drilling depth can be calculated using Eq. (1).

In Block 214, the raw frequency domain data (denoted as FFT_{raw}) is normalized into normalized frequency domain data (denoted as FFT_{normalized}) using the scaled spectral mean curve (Smc) for each drilling depth. The term “normalize” refers to removing the effect of the drill bit rotation rate on the drill bit sounds. In other words, the effect of the drill bit rotation rate on the drill bit sounds is removed by normalizing FFT_{raw} into FFT_{normalized}. The detailed procedure is described as below.

1) Using either a subtraction method or a division method to normalize the raw frequency domain data FFT_{raw}, using the scaled spectral mean curve Smc(rr):

Subtraction: FFT_{normaized}=FFT_{raw}−per₁%×Smc(rr) Assuming the drill bit rotation effects are additive noise, when the Smc is subtracted at each rotation rate, the drill bit rotation effects are removed. The second term per 1% is for avoiding negative subtraction results.

Division:

$${FFT}_{normalized} = \frac{{FFT}_{raw}}{( Smc ( rr ) \times ( 1 + {per}_{2} \% ) )}$$

Assuming the drill bit rotation effects are multiplicative noise, when we divide the Smc at each rotation rate, the drill bit rotation effects are removed when the Smc is divided at each rotation rate. The second term per 2% is for avoiding increasing division results.

In particular, per₁ and per₂ are pre-defined factors for the two normalization methods. The values used in the example of this disclosure are per₁=80 and per₂=10.

The normalized frequency domain data (FFT_{normalize}d) of the FFT data depicted in FIG. 3D above using the subtraction method and the division method are shown in FIG. 3I and FIG. 3J, respectively.

2) Calculate apparent power (Pa) from the normalized frequency domain data (FFT_{normalized}) using Equation 2 below:

$${P}_{a} {\sum }_{i = 1}^{n} {A}_{i}^{2} {f}_{i}^{2} \qquad Eq . ( 2 )$$

In Equation 2, Aᵢ is the amplitude at the i^{th} frequency index point and fᵢ is the frequency at the i^{th} frequency index point; Pa is the calculated apparent power. Specifically, the frequency range of the FFT data (i.e., horizontal axes in FIG. 3I and FIG. 3J) are divided into n frequency index points for summation in Equation 2.

FIG. 3K shows the apparent power (Pa) of the FFT data calculated using the procedure of Block 214. In particular, the plot (309), plot (310), and plot (311) represent the apparent power (Pa) of the raw FFT data (FFT_{raw}) depicted in FIG. 3D, the normalized frequency domain data (FFT_{normalized}) using the subtraction method as depicted in FIG. 3I, and the normalized frequency domain data (FFT_{normalized}) using the division method as depicted in FIG. 3J, respectively. The plot (309), plot (310), and plot (311) are superimposed with the rotation rate logs (312) for comparison. The plot (309) shows the apparent power from the raw data is affected by the rotation rate. The plot (310) and plot (311) show that after normalization, the rotation rate effects have been minimized. For example, within the low rotation rate section (313) above 3600 ft, the calculated Pa in the plot (310) and plot (311) substantially align with the high rotation rate sections (314a) and (314b) above and below. In contrast, within the low rotation rate section (313) above 3600 ft, the calculated Pa in the plot (309) substantially differs from the high rotation rate sections (314a) and (314b) above and below.

In Block 215, a drilling operation is performed based at least on the normalized frequency domain data (FFT_{normalize}d). For example, the normalized frequency domain data may be used to re-construct the time domain drill bit sounds to facilitate real time geo-steering. The re-constructed drill bit sounds with minimized rotation effect enables the drilling operator to more accurately identify formation boundaries and rock types, in order to improve or enhance drilling operations, such as precisely positioning the casing shoe by knowing where the rock boundaries are.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for drilling a subterranean formation, comprising:
generating a digitized data log of drilling sound waves from a drill bit while the drill bit advances through a depth range in the subterranean formation by cutting formation rocks to form a borehole, wherein the digitized data log comprises a plurality of drill bit sounds samples corresponding to a plurality of drilling depths throughout the depth range;
converting the digitized data log into frequency domain data (FFT data);
generating a first rotation rate cluster and a second rotation rate cluster from a rotation rate log of the drill bit advancing through the depth range;
generating a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster;
generating a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster;
generating a scaled SMC from the first SMC and the second SMC, wherein the scaled SMC represents the effect of the rotation rate on the drilling sound waves as a function of the rotation rate;
generating, based on the scaled SMC and the rotation rate log, a normalized FFT data from the FFT data, wherein the effect of the rotation rate on the drilling sound waves is reduced in the normalized FFT data; and
facilitating a drilling operation based on the normalized FFT data.

2. The method of claim 1, wherein facilitating the drilling operation comprises:
identifying, based on the normalized FFT data, formation layer boundaries and corresponding rock types; and
performing real time geo-steering based on the identified formation layer boundaries and corresponding rock types.

3. The method of claim 1, wherein generating the scaled SMC from the first SMC and the second SMC comprises:
mathematically assigning the first SMC to represent the effect of the rotation rate on the drilling sound waves for a first median rotation rate of the first rotation rate cluster;
mathematically assigning the second SMC to represent the effect of the rotation rate on the drilling sound waves for a second median rotation rate of the first rotation rate cluster; and
calculating a value of the scaled SMC for a particular rotation rate by applying a linear interpolation of the first SMC and the second SMC based on the first median rotation rate, the second median rotation rate, and the particular rotation rate.

4. The method of claim 1, wherein generating the first rotation rate cluster and the second rotation rate cluster comprises:
analyzing the rotation rate log to generate a histogram; and
identifying the first rotation rate cluster and the second rotation rate cluster from the histogram.

5. The method of claim 1, wherein generating the digitized data log of drilling sound waves comprises:
recording, using an acoustic sensor, the drilling sound waves emanating from the drill bit against the formation rocks at a particular drilling depth; and
digitizing the recorded drilling sound waves to generate a drill bit sounds sample for the particular drilling depth,
wherein the digitized data log comprises a plurality of drill bit sounds samples corresponding to a plurality of drilling depths in a depth range traversed by the drill bit penetrating the subterranean formation.

6. The method of claim 5, wherein the acoustic sensor is attached to a drive shaft of the drill bit.

7. The method of claim 5, wherein the acoustic sensor is attached to a downhole assembly adjacent to the drill bit.

8. A data gathering and analysis system for facilitating a drilling operation of a subterranean formation, comprising:
a computer processor; and
memory coupled to the computer processor and comprising instructions, when executed causing the computer processor to
generate a digitized data log of drilling sound waves from a drill bit while the drill bit advances through a depth range in the subterranean formation by cutting formation rocks to form a borehole, wherein the digitized data log comprises a plurality of drill bit sounds samples corresponding to a plurality of drilling depths throughout the depth range;
convert the digitized data log into frequency domain data (FFT data);
generating a first rotation rate cluster and a second rotation rate cluster from a rotation rate log of the drill bit advancing through the depth range;
generate a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster;
generate a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster;
generate a scaled SMC from the first SMC and the second SMC, wherein the scaled SMC represents the effect of the rotation rate on the drilling sound waves as a function of the rotation rate;
generate, based on the scaled SMC and the rotation rate log, a normalized FFT data from the FFT data, wherein the effect of the rotation rate on the drilling sound waves is reduced in the normalized FFT data; and
facilitate the drilling operation based on the normalized FFT data.

9. The data gathering and analysis system of claim 8, wherein facilitating the drilling operation comprises:
identifying, based on the normalized FFT data, formation layer boundaries and corresponding rock types; and
performing real time geo-steering based on the identified formation layer boundaries and corresponding rock types.

10. The data gathering and analysis system of claim 8, wherein generating the scaled SMC from the first SMC and the second SMC comprises:
mathematically assigning the first SMC to represent the effect of the rotation rate on the drilling sound waves for a first median rotation rate of the first rotation rate cluster;
mathematically assigning the second SMC to represent the effect of the rotation rate on the drilling sound waves for a second median rotation rate of the first rotation rate cluster; and
calculating a value of the scaled SMC for a particular rotation rate by applying a linear interpolation of the first SMC and the second SMC based on the first median rotation rate, the second median rotation rate, and the particular rotation rate.

11. The data gathering and analysis system of claim 8, wherein generating the first rotation rate cluster and the second rotation rate cluster comprises:
analyzing the rotation rate log to generate a histogram; and
identifying the first rotation rate cluster and the second rotation rate cluster from the histogram.

12. The data gathering and analysis system of claim 8, wherein generating the digitized data log of drilling sound waves comprises:
recording, using an acoustic sensor, the drilling sound waves emanating from the drill bit against the formation rocks at a particular drilling depth; and
digitizing the recorded drilling sound waves to generate a drill bit sounds sample for the particular drilling depth,
wherein the digitized data log comprises a plurality of drill bit sounds samples corresponding to a plurality of drilling depths in a depth range traversed by the drill bit penetrating the subterranean formation.

13. The data gathering and analysis system of claim 12, wherein the acoustic sensor is attached to a drive shaft of the drill bit.

14. The data gathering and analysis system of claim 12, wherein the acoustic sensor is attached to a downhole assembly adjacent to the drill bit.

15. A well system for performing a drilling operation of a subterranean formation, comprising:
a drill bit coupled to a drill string that is suspended in a borehole penetrating the subterranean formation; and
a data gathering and analysis system configured to
generate a digitized data log of drilling sound waves from the drill bit while the drill bit advances through a depth range in the subterranean formation by cutting formation rocks to form the borehole, wherein the digitized data log comprises a plurality of drill bit sounds samples corresponding to a plurality of drilling depths throughout the depth range;
convert the digitized data log into frequency domain data (FFT data);
generating a first rotation rate cluster and a second rotation rate cluster from a rotation rate log of the drill bit advancing through the depth range;
generate a first spectral mean curve (SMC) from a first portion of the FFT data corresponding to a first portion of the depth range where the rotation rate is within the first rotation rate cluster, wherein the first SMC represents effect of the rotation rate on the drilling sound waves for the first rotation rate cluster;
generate a second SMC from a second portion of the FFT data corresponding to a second portion of the depth range where the rotation rate is within the second rotation rate cluster, wherein the second SMC represents the effect of the rotation rate on the drilling sound waves for the second rotation rate cluster;
generate a scaled SMC from the first SMC and the second SMC, wherein the scaled SMC represents the effect of the rotation rate on the drilling sound waves as a function of the rotation rate;
generate, based on the scaled SMC and the rotation rate log, a normalized FFT data from the FFT data, wherein the effect of the rotation rate on the drilling sound waves is reduced in the normalized FFT data; and
facilitate the drilling operation based on the normalized FFT data.

16. The well system of claim 15, wherein facilitating the drilling operation comprises:
identifying, based on the normalized FFT data, formation layer boundaries and corresponding rock types; and
performing real time geo-steering based on the identified formation layer boundaries and corresponding rock types.

17. The well system of claim 15, wherein generating the scaled SMC from the first SMC and the second SMC comprises:
mathematically assigning the first SMC to represent the effect of the rotation rate on the drilling sound waves for a first median rotation rate of the first rotation rate cluster;
mathematically assigning the second SMC to represent the effect of the rotation rate on the drilling sound waves for a second median rotation rate of the first rotation rate cluster; and
calculating a value of the scaled SMC for a particular rotation rate by applying a linear interpolation of the first SMC and the second SMC based on the first median rotation rate, the second median rotation rate, and the particular rotation rate.

18. The well system of claim 15, wherein generating the first rotation rate cluster and the second rotation rate cluster comprises:
analyzing the rotation rate log to generate a histogram; and
identifying the first rotation rate cluster and the second rotation rate cluster from the histogram.

19. The well system of claim 15, further comprising an acoustic sensor, wherein generating the digitized data log of drilling sound waves comprises:
recording, using the acoustic sensor, the drilling sound waves emanating from the drill bit against the formation rocks at a particular drilling depth; and
digitizing the recorded drilling sound waves to generate a drill bit sounds sample for the particular drilling depth,
wherein the digitized data log comprises a plurality of drill bit sounds samples corresponding to a plurality of drilling depths in a depth range traversed by the drill bit penetrating the subterranean formation.

20. The well system of claim 19, wherein the acoustic sensor is attached to a drive shaft of the drill bit or a downhole assembly adjacent to the drill bit.
